(19) United States
(12) Patent Application Publication
(10) Pub. No.: US 2008/0296485 A1
(43) Pub. Date: Dec. 4, 2008

(54) Method and Device for Mass Spectrometry Examination of Analytes

(75) Inventors: Thorsten Benter, Haan (DE); Klaus-Josef Brockman, Solingen (DE); Marc Constapel, Ennepetal (DE); Siegmar Gab, Koln (DE); Ronald Giese, Wuppertal (DE); Oliver J. Schmitz, Dusseldorf (DE)

Correspondence Address: LAW OFFICES OF PAUL E. KUDIRKA, 40 BROAD STREET, SUITE 300, BOSTON, MA, 02109, US

(73) Assignee: BRUKER DALTONIK GMBH, Bremen (DE)

(21) Appl. No.: 11/569,145

(22) PCT Filed: May 24, 2005
(86) PCT No.: PCT/EP05/05578

§ 371 Date: Aug. 15, 2008

(30) Foreign Application Priority Data
May 24, 2004 (DE) 10 2004 025 841.4

(51) Int. Cl. H01J 49/26

(52) U.S. Cl. 250/282; 250/288

(57) ABSTRACT

The invention relates to a method for the mass spectrometry examination of at least one analyte, wherein an analyte to be examined is photoionized and the mass of the ions produced is determined in a mass spectrometer. The analyte to be examined is ionized at normal atmospheric ambient pressure by means of laser light using multiphoton ionization, especially resonant multiphoton ionization. The invention also relates to a device which comprises an ionization chamber in which an analyte to be examined is ionized at normal atmospheric ambient pressure using resonant multiphoton ionization and is transferred into a mass spectrometer. Said device can be used as an interface between a device for the chromatographic or electrophoretic separation of analytes and a mass spectrometer.

The invention relates to a method and device for the mass spectrometric examination of at least one analyte, wherein an analyte to be examined is photo-ionized and the mass of the ions is determined in a mass spectrometer.

Such methods are generally known and are used for trace analysis in the environmental field, biology, medicine, pharmacy, in the field of polymer research, synthetic chemistry, and also for process monitoring and quality assurance, for example. The method can basically be used wherever information concerning the type and composition of one or more analytes is sought.

As far as the description presented here is concerned, the term analyte is understood as a substance of any phase (solid, liquid, gaseous), or a substance mixture, whose composition and/or structure is to be analyzed.

It is generally known that mass spectrometric examinations are, for example, carried out by ionizing, for example, a molecular beam of the analyte, in, for example, the gaseous phase in order to produce ions which can subsequently be detected with a mass spectrometer. Due to instrumental constrictions imposed by the mass spectrometer and, in this case, particularly by the detector which is used, there must be a vacuum in the mass spectrometer. The complete analysis itself is therefore usually carried out under vacuum conditions, which causes substantial technical complexity.

The vacuum conditions which are necessary mean that the given particle densities are low, creating the problem that analytes which are present only in very small traces or concentrations either cannot be measured at all, or only unreliably, or not in acceptable periods of time, because the signal yield is very low.

For this reason there was a change to ionizing the analyte at higher pressure conditions and transferring the ions generated to a mass spectrometer via an interface between a first low pressure stage and a high vacuum stage, the required vacuum conditions being maintained in the latter.

The document US 2003/0075679 by Syage describes a method and equipment wherein the ionization of a gas sample is carried out under so-called “atmospheric pressure” conditions. The disclosure of this document takes “atmospheric pressure” to be a pressure which is roughly 100 times higher than the pressure in the mass spectrometer, but does not exceed 10 torr. This increase in pressure is already sufficient to improve the signal yield.

In the published document, the ionization of a gas sample as the analyte is carried out by means of single photon ionization. In order for the single photon ionization to succeed, the photon energy (PE) must be greater than the ionization potential (IP) of the analyte. For almost all relevant organic-chemical compounds (excluding, for example, alkali metals) the ionization potential is between 8 eV and 12 eV.

The photon energy must correspondingly be below approx. 150 nm, i.e. in the vacuum-UV (VUV). Such photon energies are typically provided by noble gas discharge lamps. These are commercially available but have only a relatively low photon flux density and are used when space is limited, for example. It is likewise possible to use frequency multiplied laser beams for single photon ionization, for example a laser beam with a wavelength of 355 nm from a Nd:Yag/3=118 nm=10.8 eV.

The selectivity with single photon ionization is due only to the fact that substances with an ionization potential which is higher than the photon energy of the beam used are suppressed. This is the reason why mass spectra of an analyte frequently have substances superimposed, especially auxiliary substances which are present together with the analyte in a sample, in order to facilitate the transfer into the gaseous phase or the ionization. Consequently, these can be the typical matrix materials, or so-called “doping agents”, which are familiar to those skilled in the art.

A familiar method is to set up a coupling of chromatographic/electrophoretic separation systems and mass spectrometric systems to analyze analytes which are present, for example, as the eluate of a separation method.

The currently established and most important techniques for coupling the above-mentioned separation systems can be characterized as follows:

### 1) APCI—Atmospheric Pressure Chemical Ionization

Solvent (matrix) and analyte, i.e. the eluate of the separation method, are first vaporized by heating at atmospheric pressure. Suitable additional gas streams are used for a quantitative transfer into the gaseous phase. The ionization of the matrix molecules, which are present in high excess, is then carried out with the aid of a corona discharge. Th primary ions formed react with the analyte, ionizing it. The most important process in the formation of positively charged analyte ions is the proton transfer reaction; negative analyte ions are most frequently obtained by deprotonation.

### 2) ESI—Electrospray Ionization

With this method, solvents and analyte molecules from the liquid phase are electrostatically charged and transferred into very small droplets by forming a spray at atmospheric pressure. Vaporization processes cause these droplets to shrink to a point where the electrostatic forces due to the high concentration of charge carriers cause them to be torn apart. It is during this process that the transfer of charge to the analyte molecules occurs; the most common reactions are again protonation or deprotonation of the analyte, and also the attachment of matrix ions such as Na⁺ or NH₄⁺.

### 3) APPI—Atmospheric Pressure Photo Ionization

The two aforementioned methods can only efficiently ionize polar analyte molecules. Recently, a third method of ionization at atmospheric pressure has been used. This method is based on the direct photoionization of the analyte molecules using suitable VUV (vacuum-UV) radiation (usually 10 eV photons, λ=124 nm). The energy of the incident photons is selected so as to be below the ionization energy of the matrix molecules but above the ionization energy of the analyte molecules. This means that non-polar substances are also available for mass spectrometric analysis. With APPI, the radical cations M.⁺ formed directly by absorption, as well as protonation and deprotonation stages and electron attachment are observed. Intensive research is currently being undertaken to explain this, at present unexpected, mechanism. Rearrangement reactions of electronically highly excited matrix molecules and cluster formation, followed by photoionization of the reaction products and subsequent ion molecule reactions with the analytes play a significant role in this.

The aforementioned methods are partly based on chemical ionization processes and are thus subject to kinetic and thermodynamic control. Non-polar substances are available only with difficulty for an efficient ionization.

The selectivity of the aforementioned ionization methods comes from the kinetic and thermodynamic control in the reaction region. This is accompanied by competition for primary charge carriers in the reaction region. If there is a large excess of one analyte component, components which are present in insufficient quantities could be completely suppressed, i.e. the ion yield is dependent on the matrix composition, making it much more difficult to quantify the analyte under these conditions.

The said method of single photon ionization gets around this control mechanism by forming analyte ions directly by absorbing VUV photons (typ. 10 eV). Selectivity in respect of the analyte molecules is achieved since only substances with an ionization potential below the photon energy used can undergo primary ionization. However, the strongly increasing absorption cross sections of most organic compounds in the vacuum ultraviolet (VUV) wavelength range can cause interferences to occur as a result of unexpected photoreactions of the matrix molecules.

Moreover, an uncontrolled fragmentation of the analyte can also occur with the aforementioned methods, making it more difficult to interpret the spectra.

It is the objective of the invention to provide a method for mass spectroscopic investigations of analytes also at extremely low concentrations and a corresponding device. The device should form a link between an ionization stage and a mass spectrometric analyzer, in particular with the analyte being taken from an upstream separation stage.

Furthermore, the objective is to transfer the analyte as efficiently and gently as possible into the gaseous phase, and to transport it with as few losses as possible from the ionization stage and/or the chromatographic/electrophoretic separation stage into the high vacuum region (e.g. p≦10⁻⁸ atm) of the mass spectrometer.

The aim here is to ionize the analyte as selectively as possible and with high efficiency.

This objective is achieved according to the invention by ionizing the analyte at normal atmospheric ambient pressure by means of laser light using multiphoton ionization, especially resonant multiphoton ionization.

In this case, atmospheric ambient pressure is taken to be a pressure of around 1 atm or approx. 1,000 mbar, or approx. 760 torr, or the pressure in the lower troposphere, in contrast to the information concerning “atmospheric pressure” given in the aforementioned literature.

The advantage of working in this pressure range is that, for one, there is a high particle density in the ionization volume, and thus it is possible to detect even very small traces of substances in an analyte with high signal yield. Moreover, the analyte in the ionization volume is favorably at room temperature.

With the method according to the invention, at least 2 photons are used for ionization (e.g. two photons which are either identical or which have different wavelengths). Multiphoton ionization (MPI) therefore occurs. The ionization volume is at atmospheric pressure, and the ions generated are transferred into a mass spectrometer.

It is preferable if the wavelength of the first photon is resonant with an electronically excited, photostable state in the analyte. In this case, the lifetime of the analyte following absorption of the first photon is so long that a second photon can be absorbed before returning to the ground state (or dissociation). To carry out resonant multiphoton ionization in particular, lasers are used to provide the required minimum photon flux of around 10⁵ W/cm². It is preferable to work with pulsed lasers. For example, it is possible to use energies of 20 mJ at a 10 ns pulse duration=2×10⁶ W. This power is preferably spread over an ionization volume of around 1 cm².

With resonant multiphoton ionization the method according to the invention is selective regarding analytes which absorb in the energy range of the first photon. If this wavelength is at 248 nm, for example, and if no other wavelength is also incident, the method is selective for aromatic compounds. In the wavelength range given as an example, these frequently have a) very stable transitions, and b) the absorption of a further photon from the electronically excited state is sufficient to exceed the ionization potential.

Wavelengths can also be mixed: for example 308 nm for the excitation and 193 nm for the ionization etc.

The resonant excitation means the selectivity is high and it can be selected by selecting the wavelength of the first exciting photon. It is thus possible to specifically search in an analyte for traces of substances which resonantly absorb at the excitation wavelength.

At atmospheric ambient pressure, resonant multiphoton ionization has boundary conditions which are not possible with conventional multiphoton ionization in a molecular beam.

The ionization volume can therefore be several orders of magnitude greater, e.g. at least 1 cm³ compared with a maximum of 1 mm³ in the molecular beam. This is preferably still dependent on an ion focusing system which can optionally be used to focus the ions into the entrance aperture of a mass spectrometer. Compared to molecular beam methods, the method according to the invention is remarkably sensitive since, in addition to the large ionization volume, the density does not fall off with 1/r², as is usually the case for molecular beams.

This advantage of the method according to the invention can preferably be used if the volume in the ion source which the mass spectrometer can see is of the same order of magnitude as the ionization volume. This, in turn, succeeds favorably with orthogonal time-of-flight mass spectrometers and multipole instruments.

It is preferable to use a mass-selective detector with a resolution in the region of 10,000. The generation of low-fragment mass spectra, obtained with the method according to the invention (e.g. with an ionization laser power density of around 1 GW/cm²), provides analytically relevant data.

According to the invention, the design of the method can be such that an analyte is introduced into an ionization volume located in an ionization chamber at atmospheric pressure which is connected to a mass spectrometer.

The analyte may be introduced in a gaseous state, either directly, e.g. as a gas sample out of a feed-in aperture or out of capillaries, or as eluate of a chromatographic or electrophoretic separation stage, e.g. simply from a gas chromatograph.

In a preferred development, the analyte is transferred as a liquid eluate of a liquid chromatograph into the ionization chamber. In such a case, the liquid eluate is vaporized with a laser beam, in particular from an infrared laser, preferably in pulsed operation. The arrangement here is selected so that the eluate expands into the ionization volume, where it is ionized in the gas/vapor and/or aerosol phase. With this arrangement, the eluate forms a composition of analyte and a matrix, which is typical for the chromatographic stage.

All systems for introducing an analyte into the ionization volume can be designed so that the ionization chamber is purged with a buffer gas in order to avoid undesired superpositions in the mass spectra as a result of impurities.

Compared to conventional methods, method and device according to the invention lead to a marked improvement of the overall transmission of the analyte, and hence to a markedly increased sensitivity. The crucial factor is that the individual components of the system (vaporization stage, ionization stage and mass spectrometer) are strictly coordinated.

The ionization chamber here is preferably an interface between a chromatographic/electrophoretic and a mass spectrometric stage, where, according to the invention, the analyte can be transferred in its matrix (mobile phase) into the gaseous phase at 1 atm total pressure. This is necessary, for instance, if liquid chromatography (LC) or capillary electrophoresis (CE) is used. The analyte can be ionized selectively by means of resonance-amplified two-photon absorption with the aid of one or more pulsed UV lasers, for example, and the analyte ions can be transferred into a mass spectrometer with as few losses as possible.

Compared to the continuous mode of operation, the use of a pulsed infrared laser system to vaporize the matrix material of the separation stage (e.g. LC, CE) leads to an increased concentration of the analyte in the ionization volume.

The vaporization energy coupled into the matrix can be precisely adjusted via the IR laser power density. Likewise, the repetition rate can be adjusted from a few pulses per minute to the tenth of a second range to meet the requirements of the separation stage. Operating the interface at atmospheric pressure leads to a very fast cooling of the vaporized material to room temperature since the mean free path under these conditions is considerably less than 10⁻⁶ m. This provides a gentle, pulsed transfer of the analyte into the gaseous phase.

The analyte is ionized selectively by means of a two-step (or three-step) excitation with pulsed UV laser light, for example. Both single and two-color excitations are used. This creates the following advantages:
a) The analyte is ionized directly by two-photon absorption. There is no competition between the charge carriers, as occurs with chemical ionization. The incident photon density is always high enough to exclude such a competition with certainty.
b) The UV photon energy is in the region between a minimum of 3.5 eV (350 nm) and a maximum of 6.4 eV (193 nm), for example. In this region, the matrix materials typically used for the chromatographic separation are almost transparent so that any photo-excitation of these materials can almost be excluded.
c) A high selectivity of the ionization process is achieved by the two-step ionization of the analyte. It is successful only when
   in the first step there is a strong absorption with relatively long-lived electronic states. For example, almost all aromatic systems exhibit this behavior for their S₀-S₁ transition in the wavelength range 350-250 nm.
   the second step leads directly from the excited state to ionization. The wavelength used for the ionization depends on the value of the ionization potential of the analyte and requires special attention when fast intramolecular relaxation processes are to be expected after absorption of the first photon, e.g. radiationless singlet-triplet transitions.
   As a rule, the ionization only requires a second photon of the same wavelength to succeed.
d) The power densities used for efficient two-photon ionization are between 10⁵ and 10⁷ W cm⁻². These are provided by very compact excimer lasers with high repetition rates, for example. Under these conditions, the ionization volume is ≧1 cm³, and thus optimal for the expansion volume of the IR laser vaporization stage.

The degree of fragmentation for determining structural elements in the analyte can be controlled by means of the photon flux or the laser power densities used. Under the aforementioned conditions, in general only the formation of molecular ions is observed. Changing the focusing of the laser beam by a factor of up to 100 makes it possible to change the degree of fragmentation within wide boundaries. Thus, besides the established “in source” and “post source” CID (collision induced decomposition) methods, there is also a further, completely independent method of generating fragment ions for structure determination.

One example of an embodiment of the invention is presented in the illustrations below. They show:

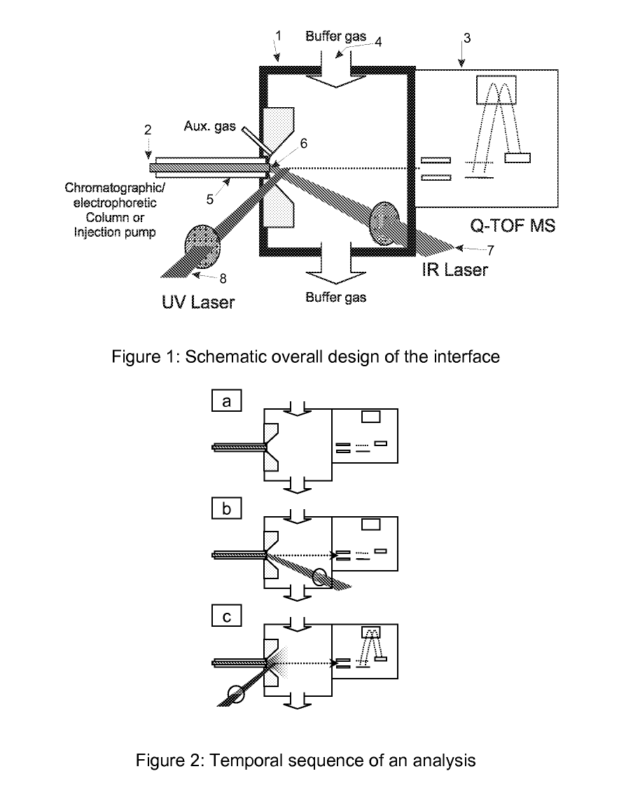

FIG. 1: A schematic representation of an ionization chamber according to the invention with upstream separation stage and downstream mass spectrometer;

FIGS. 2a)-c): The temporal sequence for the pulsed generation of ions;

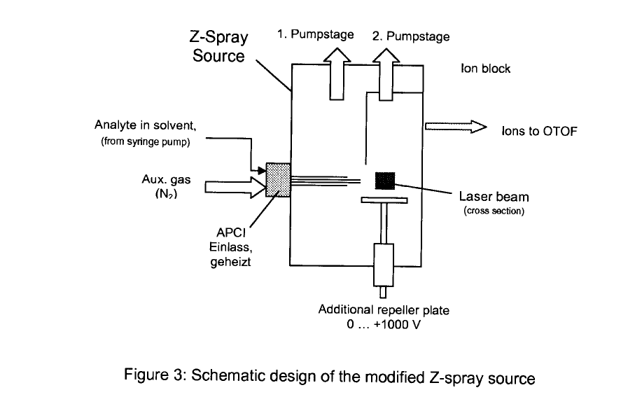

FIG. 3: The ionization chamber with interface to a time-of-flight mass spectrometer with alternative analyte introduction;

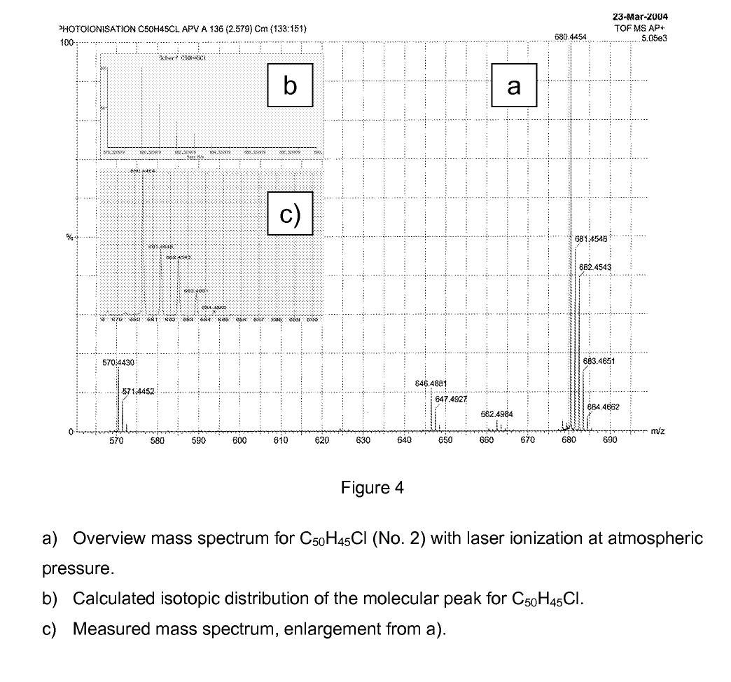

FIGS. 4-6: Mass spectra obtained for various analytes;

Table 1: Analytes examined;

FIG. 1 shows the schematic representation of the overall design of an instrument according to the invention. The part with the bold border in FIG. 1 is the most important subject matter of the invention, the ionization chamber 1 and the interface between separation stage 2 and mass spectrometer 3. Together with the laser systems it forms a single unit. In the ionization chamber 1 there is a pressure of approx. 1 atm, i.e. ambient pressure. In this case, the ionization chamber 1 can be purged with a buffer gas 4.

FIGS. 2 a)-c) illustrate the temporal sequence for the pulsed generation of ions after the pulsed laser vaporization. The additional gas flows/pulses for purging the ionization volume are not shown.

With reference to FIG. 2a), a drop of eluate 6 is first formed at the end of the chromatographic column 5, said drop containing a matrix material as well as the analyte to be analyzed.

As is shown in FIG. 2b), this eluate drop 6 is desorbed, i.e. vaporized, by means of a pulsed IR laser beam 7, which illuminates the end of the column 5. The eluate 6, and with it the analyte, expands into the ionization volume of approx. 1 cubic centimeter, cooling to room temperature as it does so.

FIG. 2c) depicts the resonant two-photon ionization of the vaporized analyte, by means of a UV pulse, for example.

If the interface is coupled with a gas chromatographic column there is no desorption stage. In this case, the gas emerging from the column is ionized directly.

Any means of providing an analyte can be used in conjunction with the method according to the invention.

Accordingly, FIG. 3 represents an alternative ionization chamber 1 where the analyte is injected into the ionization chamber 1 in a solution in combination with an auxiliary gas.

In this application, the interface to the time-of-flight spectrometer is shown in more detail. In the form shown, this interface can also be used with all other types of analyte provision.

After the analyte ions are generated, they are literally sucked into the mass spectrometer by the prevailing pressure conditions. This can be done using an aperture in the form of a skimmer, for example, between the ionization chamber at atmospheric pressure and the mass spectrometer, which is under vacuum.

An ion focusing system can preferably be used to guide the ions generated into the connecting aperture by means of electric and/or magnetic fields, for example, thus helping to increase the yield. Specially designed electrodes at positive potential can be used for this.

The suction effect imparts a velocity component to the ions in the direction of suction through the aperture between ion chamber and mass spectrometer, making it very favorable to use an orthogonal time-of-flight mass spectrometer, which deflects the ions at right angles to the direction of aspiration by means of a preferably pulsed electric field. This can occur in a differential pump stage. In the time-of-flight mass spectrometer, an ion reflector can be used to compensate for the velocity dispersion of the ions and increase the resolution.

In a preferred development, the pulses for controlling the electric fields which guide and/or deflect the ions are temporally synchronized with the laser pulses used to vaporize and/or ionize the analyte.

To validate the ionization method, the resonant two-photon ionization was carried out at atmospheric pressure. The design is shown schematically in FIG. 3. A Micro-Mass QTOF Ultima was used for the mass-selective ion detection. The instrument is equipped with a factory-installed Z-spray admission stage comprising a housing with flanges to connect it to the MS and also to hold an APCI or ESI source, the “ion block”, which forms the admission aperture to the MS, and the corona needle.

The housing of the Z-spray admission stage was redesigned. Compared with the original design, additional apertures have been included for a laser beam to enter and emerge. Likewise, additional electrodes have been mounted to manipulate potential fields in the source.

The analytes were first dissolved in a suitable solvent and transferred through the heated APCI source and into the gaseous phase by means of controlled injection with the aid of a spray pump. In these experiments the corona needle was not mounted.

Table 1 gives an overview of the analytes analyzed and the solvents used.

After switching on the UV laser (Lambda Physik Optex, KrF*, λ=248 nm, 100 Hz), ion signals were obtained which, after optimizing the position of the laser beam and the ion source potentials, led to the mass spectra shown as examples in FIGS. 4, 5 and 6.

PAHs such as fluoranthene (see Table 1, No. 1) were used in the analyses, as were three polymer building blocks (see Table 1, No. 2-4). Apart from varying numbers of halogen atoms (see Table 1, No. 2 and 3), they also contained covalently bonded metal atoms (see Table 1, No. 4).

The polymer building blocks were synthetics whose identity and yield were to be determined.

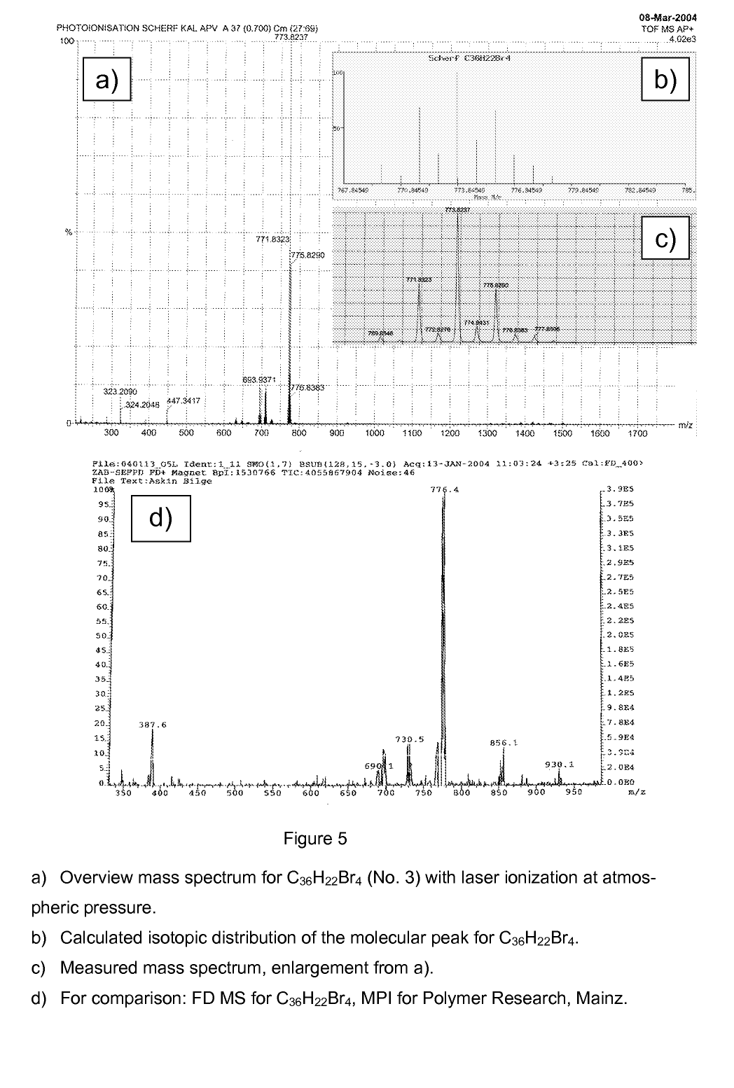

The mass spectra illustrate the high potential of the method according to the invention. In particular, as shown in FIG. 5, the comparison between mass spectra according to the invention and mass spectra generated by field desorption mass spectrometry (FD-MS) from the Max Planck Institute for Polymer Research in Mainz. FD-MS is currently regarded to be the “state-of-the-art” for these materials. The similarity for polymer building block no. 5 is impressive.

The analysis time, which is around 45 minutes for FD-MS but only 5 minutes for the method according to the invention, should also be emphasized.

The prototype system was found to have an exceptionally high sensitivity and low detection limit. The installation of an additional repeller plate, in particular, led to a great increase in sensitivity. Even with continuous injection (900 μl min⁻¹) of a 5 nanomolar solution of fluoranthene (No. 1) in a methanol/water mixture, clear ion signals were still obtained for an integration time of 1 s. The amount injected during this time corresponds to around 100 fmol.

It is expected that further optimization, such as the synchronization of the laser pulse frequency with the digital data acquisition system of the mass spectrometer, will increase the sensitivity even further.

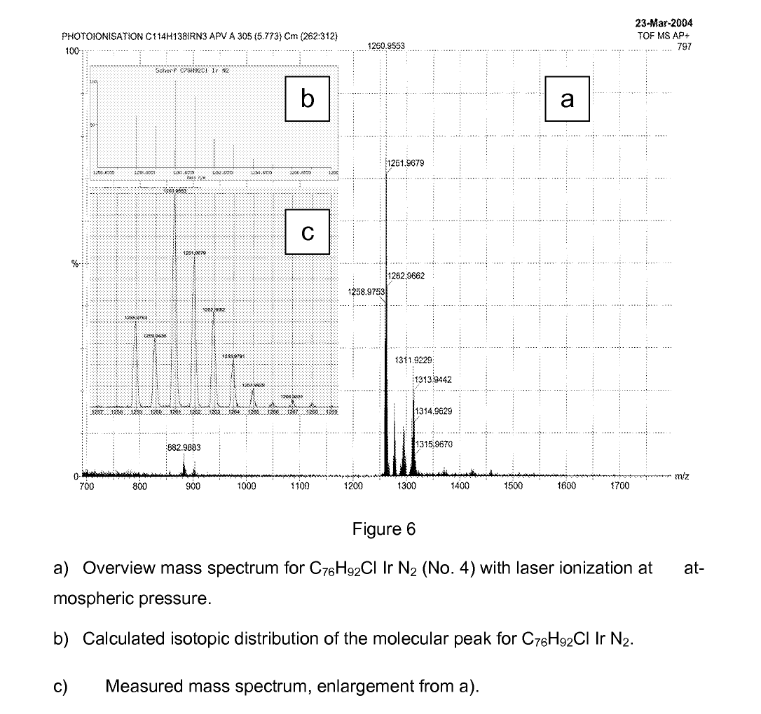

TABLE 1

| | | | Molecular | | |
|---|---|---|---|---|---|
| | | Sum | mass | | |
| Nr | Analyte | formula | [g mol⁻¹] | Solvent | Comment |
| 1 | 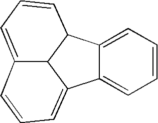 | C₁₆H₁₀ | 202.25 | CH₃OH/H₂O | SensitivityDetermin-ation |
| 2 | 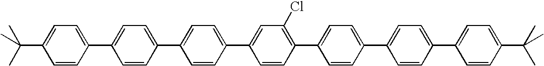 | C₅₀H₄₅Cl | 681.36 | CHCl₃ | see FIG. 4 |
| 3 | 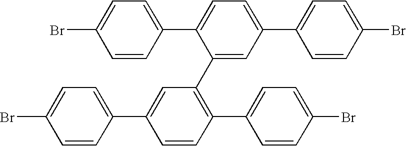 | C₃₆H₂₂Br₄ | 774.18 | CHCl₃ | see FIG. 5 |
| 4 | 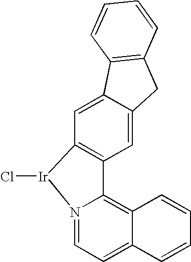 | C₇₆H₉₂ClIrN₂ | 1261.25 | CHCl₃ | see FIG. 6 |

1. Method for the mass spectrometry examination of at least one analyte, whereby an analyte to be examined is photo-ionized and the mass of the ions produced is determined in a mass spectrometer,
wherein the analyte to be examined is ionized at normal atmospheric ambient pressure by means of laser light using multiphoton ionization, especially resonant multiphoton ionization.

2. Method according to claim 1, wherein an analyte is introduced into an ionization volume located in an ionization chamber which is at atmospheric pressure and which is coupled to a mass spectrometer.

3. Method according to one of the previous claims, wherein the ionization chamber is purged with a buffer gas.

4. Method according to one of the previous claims, wherein the analyte is introduced into the ionization volume as eluate of a chromatographic or electrophoretic separation stage.

5. Method according to claim 4, wherein a liquid eluate of a separation stage is vaporized by means of a laser, especially an infrared laser, wherein particular the eluate expands into the ionization volume.

6. Method according to one of the previous claims, wherein the ionization of an analyte is carried out selectively by excitation with UV laser light, particularly pulsed UV laser light, particularly where the ionization is carried out from the excited state with a photon of the same or a different wavelength.

7. Method according to one of the previous claims, wherein a fragmentation of the analyte is influenced by changing the laser intensity.

8. Method according to one of the previous claims, wherein a time-of-flight mass spectrometer, in particular an orthogonal time-of-flight mass spectrometer, is used to determine the mass of the ionized analyte.

9. Method according to one of the previous claims, wherein the ions generated are focused into the entrance of the mass spectrometer by means of an ion focusing system.

10. A device, particularly to carry out a method according to one of the previous claims, wherein it incorporates an ionization chamber in which at normal atmospheric ambient pressure an analyte to be analyzed can be ionized by resonant multiphoton ionization and transferred into a mass spectrometer.

11. A device according to claim 10, wherein it can be used as an interface between a device for the chromatographic or electrophoretic separation of analytes and a mass spectrometer.
